(19) United States
(12) Patent Application Publication
(10) Pub. No.: US 2011/0264536 A1
(43) Pub. Date: Oct. 27, 2011

(54) DISTANCE DEPENDENT ADVERTISING

(75) Inventors: BENJAMIN E. CHODROFF, CLEVELAND, OH (US); PANKAJ S. ZANWAR, PUNE (IN)

(73) Assignee: INTERNATIONAL BUSINESS MACHINES CORPORATION, ARMONK, NY (US)

(21) Appl. No.: 12/765,413

(22) Filed: Apr. 22, 2010

(51) Int. Cl. G06Q 30/00

(52) U.S. Cl. 705/14.69; 705/14.72

(57) ABSTRACT

At least one virtual users in a virtual world can be identified, wherein the at least one virtual user is within a viewable distance of at least one advertisement display point. A distance dependent advertising plan can be created for the advertisement display point that varies based on the distance between the virtual user and the at least one advertisement display point. The advertisement plan can contain different advertising content items for presenting within the advertisement display point. Different ones of the different advertising content items are presented in accordance with the advertisement plan when the virtual user is at different distances from the at least one advertisement display point. The different advertising content items can be displayed at the advertising display point in the virtual world based on the advertising plan.

### BACKGROUND

Embodiments of the invention relate to the field of advertising and more particularly, to advertising with content that changes based on a distance of an observer relative to the advertising.

In both real and virtual worlds (e.g., worlds formed within a computer simulation), space is a considered to be a precious commodity and maximizing profits from a fixed advertising space requires creative thinking. At a simple level, one can take a fixed amount of advertising space and split it among many ads. Another possibility is to have time-sharing of space by rotating an advertisement, therefore displaying multiple advertisements in the same location over a period of time. This time might be for days or seconds but the idea is essentially the same. However, one concept that has yet to be explored by known references is the notion of distance dependent advertising.

### BRIEF SUMMARY

One embodiment of the disclosure is for distance based advertising, where content within an advertising space changes based on an observers distance to that space. That is, when a person is closer to an advertisement, it is easier to see and subsequently easier and quicker to read. On the other hand, when a user is farther away, the advertisement appears smaller and it is harder to read and takes longer to process but advertisers have traditionally been charged the same amount no matter where the user is located. If users are close to the advertisement, it would be more advantageous to charge the advertiser more for the space they are utilizing. Additionally, it would be possible to show multiple advertisements in the same space now that the user is closer since their field of view is limited. These multiple advertisements can be for the same or different entities (e.g., for a single fee, an advertiser can select different content for the advertisement that is selectively presented based on the distance—or different distances can be sold to different entities for different amounts). In one embodiment, the distance space becomes more valuable as the user is closer. Additionally, the amount of space required for an advertisement to have the same affect on a user is relative to the distance the user is from the advertisement. One specific configuration, elaborated upon herein, for distance dependent advertising is for providing a distant dependent advertising solution for virtual worlds.

One aspect of the invention is for a method, system and computer program product for distance dependent advertising, and more specifically for distance dependent advertising in virtual worlds. Embodiments of the invention start by identifying the Avatar's and display point of this virtual world where “Avatar” is a computer user's representation of himself or herself in the form of a three dimensional model and “display point” is the location where the advertisement is displayed. Then, according to a further embodiment of the invention an advertisement plan for each display point is created.

Embodiments of the invention in this plan contain all the control parameters for all the advertisements destined for this display point. These control parameters include but are not limited to at least one of: sponsors of the advertisement, times of days of advertisement, distance of the Avatars from the display point, and distance of the groups of advertisements from the display point.

In a further embodiment, the Avatar distance monitoring is started and in each monitoring interval, the distance to display point is measured, average distance or weighted average distance is calculated and based on advertisement plan rules the content and display format of the advertisement on this display point is modulated. Finally, sponsor's accounts for each advertisement displayed on this display point are updated based on the rules in the advertisement plan.

### BRIEF DESCRIPTION OF THE SEVERAL VIEWS OF THE DRAWINGS

FIG. 1 is an exemplary embodiment of a data flow diagram showing advertisement creation plan used in an embodiment of this invention.

FIG. 2 is an exemplary embodiment of a data flow diagram showing Avatar's distance calculation and advertisement modulation used in an embodiment of this invention.

FIG. 3 is an exemplary embodiment of a data flow diagram showing advertisement modulation used in an embodiment of this invention.

FIG. 4 is an exemplary embodiment of a data flow diagram showing advertisement sponsor charge account finalization used in an embodiment of this invention.

FIG. 5 illustrates an exemplary embodiment of a data processing system on which the data flow of FIG. 1 to FIG. 4 is implemented.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

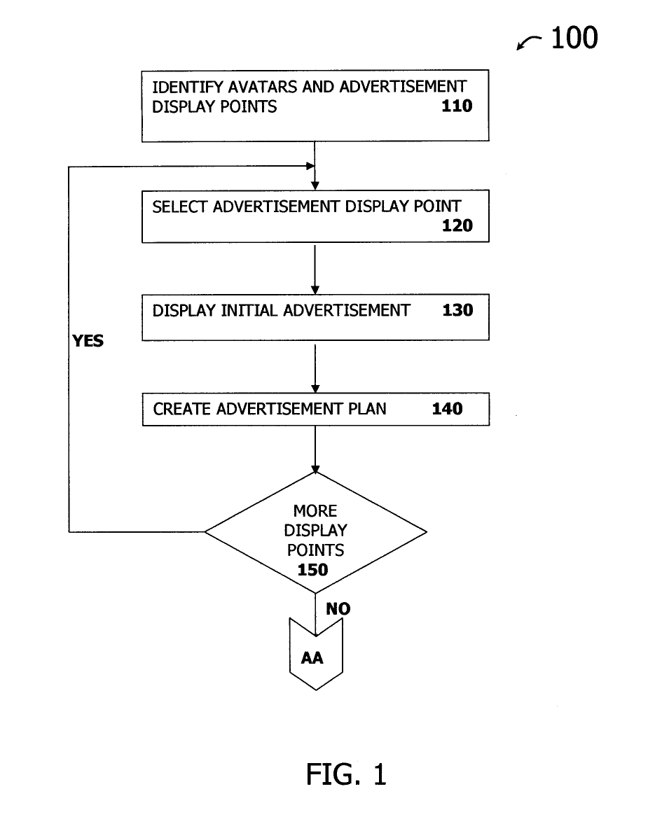

An embodiment of this invention is a method for distance dependent advertising in virtual worlds. An embodiment starts as disclosed in accordance with an exemplary embodiment in FIG. 1, and begins by identifying Avatars and advertisement display points for this virtual world (110). Avatar is a computer user's representation of himself or herself (or a fictitious character) in the form of a three dimensional model. An Avatar may be displayed within a view screen (to others), may be displayed in part to a user (e.g., his/her own Avatar is shown in a perspective view), and/or may be hidden from a user, who “sees” within a virtual world from the eyes of the Avatar (e.g., first person perspective view). These views can be subject to user configurable settings in one embodiment of the invention. The important part is content of advertisements is dependent on a position of the Avatar relative to an advertisement display point of the virtual world. Next, from the list of advertisement display points, one is selected (120) and one or more initial advertisement is projected (130). At this point an embodiment creates an advertisement plan for this display point (140). This advertisement plan contains at least one of the rules pertaining to advertisement that is displayed on this display point.

These rules, for example, comprise: sponsors of the advertisement, times of days of advertisement, distance of the Avatars from the display point, distance of the groups of advertisements from the display point, rotation interval of the advertisement related to distance of Avatar or groups of Avatars from the display point, footprint of advertisement in relation to the distance of the Avatar or groups of Avatars from the display point, relationship of advertisements or if they can be displayed simultaneously on different area of display point, display angle and viewable angle of advertisement in relation to Avatar's or group of Avatars' distance from the display point, accounting and rate rules for each advertisement in relation to rotation rate, distance, footprint and advertisement display type in relation to Avatar's distance or groups of Avatars' distance. This display type is not limited to slide show, video or audio or any form of digital media delivery. If more display points are available (150), steps 120, 130, and 140 are repeated.

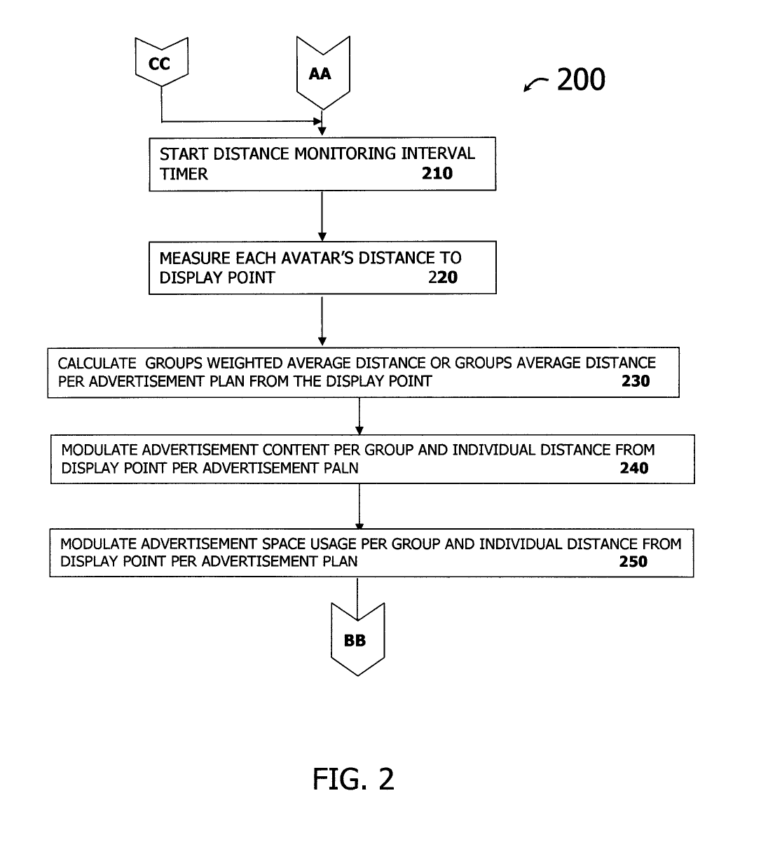

Now referring to FIG. 2, a further exemplary embodiment of the invention embodiment begins the distance monitoring interval timer (210). This is the interval where Avatar distance from the advertising display point is re-measured and average distances are recalculated. This interval is defined in advertising plan for this display point. Next, distance of each Avatar from the display point is measured (220) and group's average distance or weighted average distance (230) is recalculated. The decision to use average or weighted average is also defined in advertisement plan. The weight of each Avatar's contribution to this distance is also defined in advertising plan which is used for calculating weighted average if this option is requested in advertisement plan.

In an embodiment, this average distance is used to search the advertisement plan and extract the rules to modulate the content of displayed advertisement on the display point (240) per advertisement plan. Then, this average distance is used to reallocate and modulate space usage for each displayed advertisement (250) per advertisement plan as the group gets closer to the display point the display area could be less.

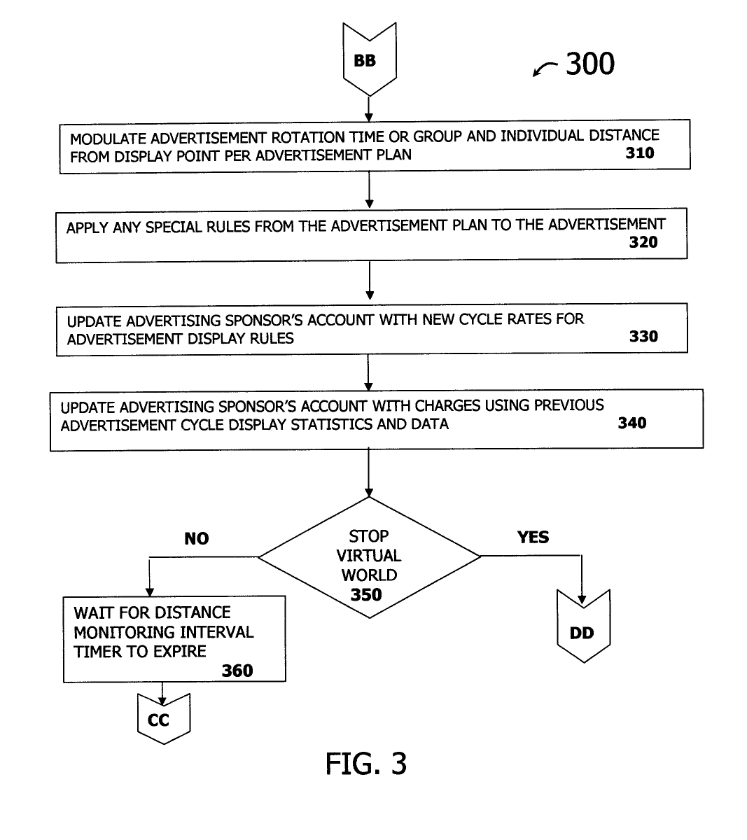

Next, as illustrated in FIG. 3 in an exemplary embodiment, advertisement rotation times (310) are modified per advertisement plan where at closer distance to display point, advertisements could be rotated faster, and finally any special rules from advertisement plan (320) is applied; this could be but not limited to changing the slide show to full video or replacing the contents at a closer distance per sponsor's advertisement.

At this point, an embodiment updates the advertisement sponsor's account (330) with new rate related parameters such as but not limited to rotation rate, display distance, advertisement space usage and number of Avatars in proximity. Then, sponsor's account is updated (340) with charges from the previous monitoring cycle per previous display parameters.

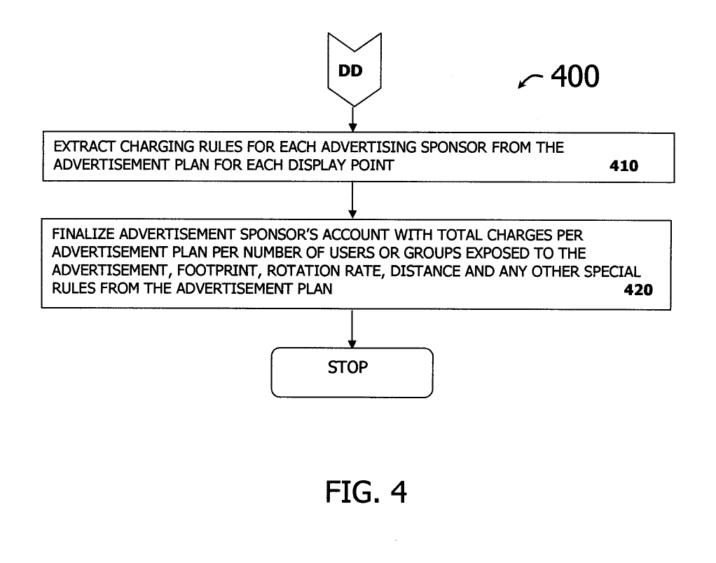

In one embodiment, a decision to end the advertisement plan and virtual world is made. If advertisement plan is stopped (350), charging rules for each advertisement and sponsor for each display point from its corresponding advertisement plan is extracted (410), as illustrated in FIG. 4, in an exemplary embodiment. Then, these parameters, for example, but not limited to, the number of advertisements, number of Avatars exposed to the advertisement, footprints, rotation rates and distances for exposure is used to calculate the total usage rate of each sponsor and finalize the account (420).

In one embodiment, if advertisement plan and virtual world is not stopped (350), distance monitoring is stopped (360) until monitoring interval timer specified in the advertisement plan is expired. Then, in one embodiment, steps 210-250 and 310-350 may be repeated.

An exemplary embodiment is a method for distance dependent advertising for virtual worlds. First, virtual users in this virtual world are identified, where these virtual users are one or more users, where these virtual users are in viewable distance from advertising display point, and this virtual world is a computer based simulated environment, where virtual world's users are Avatars. Avatars are, for example, computer users' representation of themselves as characters in a virtual world, where these characters are three-dimensional characters in this virtual world, where Avatars are the virtual world users, and advertising display point is location where advertising content is displayed. At this point, all the users targeted for this advertising display point are identified and advertising plan can be utilized.

An exemplary embodiment creates an advertising plan, where the advertising plan contains every advertising content for this advertising display point, where this advertising plan comprises: advertising sponsors for every advertising content, display distance rules for every advertising content, charge rates for every advertising content for advertising sponsors, and display types for user's distance for the advertising content, where display types comprise slides, banners, videos or any form of digital advertising media, where this advertising plan comprises display types for user's distance from advertising display point, group rules for groups of user's for average distance from advertising content, viewable distance rules for advertising content, and rotation time rules for advertising content based on viewable distance of groups and user's. This advertising plan defines all the rules of displaying the content based on the distance of the user, weight or priority of the users, groups of the users and sponsors of the advertisements.

Next, an exemplary embodiment displays one or more of advertising content on advertising display point, where this one or more of advertising content is advertisement delivered by one or more sponsors from the advertising plan. Next, the exemplary embodiment calculates each user's distance to advertising display point. This distance is one of the parameters used to execute the advertisement plan and change the advertisement contents. Then group distance to advertising display point is calculated, where this group distance is average or weighted average distance between the users and the advertising display point, where the group average is mathematical average of user's distance from advertising display point, and weighted average is sum of each user's distance times each user's weight divided by sum of user's weight, where user's weight is contribution of user to the distance. This is another parameter used for execution of the advertisement plan and changing the advertisement contents.

Next, an exemplary embodiment searches the advertising plan for user's distance and group's distance. Then special rules for user's distance and group's distance from the advertising plan is extracted, where these special rules are viewable distance rules and rotation time rules and group rules and distance rules. Then, these special rules are applied on one or more advertising contents for advertising display point.

An exemplary embodiment charges rates from advertising plan for one or more advertising contents for this display point is extracted, and charge accounts for sponsors of one or more advertising contents with charge rates and special rules are updated.

In one exemplary embodiment, if an option activated or selected, the groups and user's rates and viewable distance rules and rotation time rules are aggregated, averaged, or combined statistically by using, for example, AND or OR logic operations, weighted average, normalized with the standard deviation, or using normal distribution of the rates or rules, as normalization factor. In one embodiment, if an option activated or selected, the groups and user's rates and viewable distance rules and said rotation time rules are evaluated separately, based on individual groups and users. In one embodiment, the above activations or selections are based on any one of the following: user's preference, predetermined rules, dynamically variable and adjustable rules, neural network based, or fully-automatic.

In an exemplary embodiment, the user's weight is based on the level of previous interactions between the user and the advertisement, for example, the number of times the user responded to the advertisement by selecting its content, the amount of time the user spent observing the advertisement during the past showing(s), the average amount of time the user spent observing the advertisements in a period of time such as past month, the frequency of user's interactions with advertisements, i.e., number of interactions per a unit of time. Also, the weight of the user may vary based on specific subject areas for ads. For example, a user may be a sports fan, and he/she may be more interested in seeing ads related to sports. In an embodiment, a subject area, for example, from available subject areas, is selected so to maximize the average user weight for the group. In an exemplary embodiment, the average user weight is itself weighted by the users' distance to the advertisement, in determining the ad subject area with highest average user weight for the group.

In one embodiment, an Avatar's position relative to a display point can be adjusted based on visual specifics of the Avatar. For example, if the Avatar is looking through a telescoping lens in the virtual world, the distance calculated between the Avatar and the display point of an advertisement can be based on the effective focal length of the Avatar (therefore if using a 300× zoom, the distance between the display point and the Avatar could be calculated as 1/300 of the actual distance between the Avatar's position and the display point's position).

Further, display characteristics and user perspective can be used to calculate distance for advertising purposes, in one embodiment of the invention. For example, if a virtual world is being accessed from a mobile device having a small screen, a user may have difficulty reading content displayed within an advertisement within the virtual world—relative to the same user's ability to read the same advertisement on a large display. Thus, a distance adjustment can be performed, so that the “effective” distance between an Avatar and the display point is further than normal (since larger print is required on the small screen, and larger print can be associated with advertisements viewed from a longer distance). Similar adjustment can be made for large screens and/or relatively large views (due to display properties, such as display settings having different resolutions). Thus, an effective distance for distant dependent advertising can vary in one embodiment when a virtual world is viewed with display resolution settings of 1680×1050 pixels, of 1024×768 pixels, or 800×600 pixels.

The overarching concern can be providing an effective means to advertise within a fixed space within the virtual world, where the content of the fixed space changes based on proximity of an Avatar, or effective distance to an advertisement. Proximity of an Avatar can equate to an ability of a reader (e.g., user to whom the advertisement is presented) to digest the content presented in the fixed space. Thus, appropriate adjustments can be made to ensure that the advertising content is conveyed in a manner appealing to advertisers, which concurrently maintains the integrity of the virtual world (e.g., the region of the fixed space for advertising is treated as a non-expanding region of virtual space, just as neighboring regions proximate to the fixed space or display point). In other words, in one embodiment, the fixed space is not able to grow, shrink, or alter its relative size within the virtual world to get a user's attention, but is able to change its content to ensure effective conveyance of an advert, based on distance.

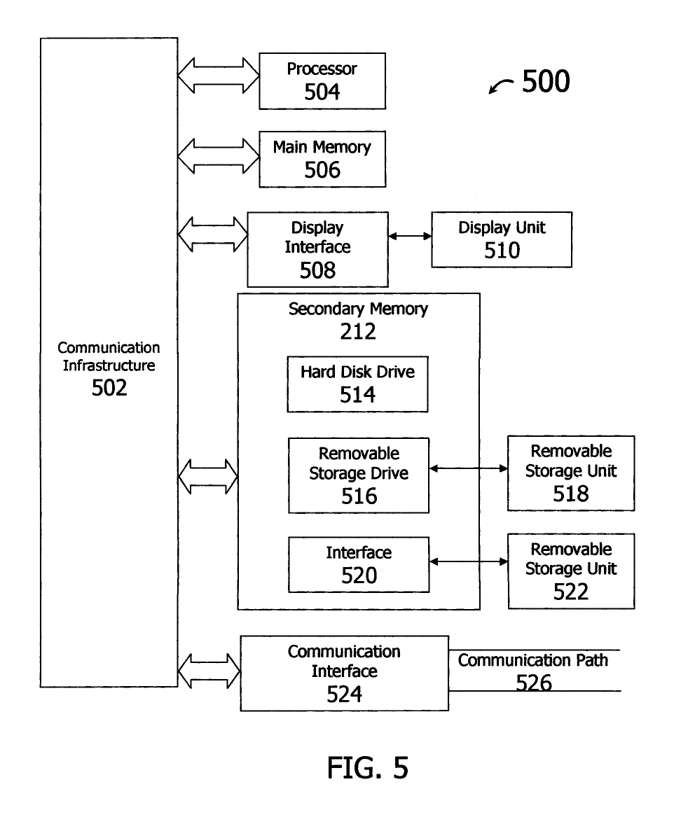

FIG. 5 shows a detailed schematic of a data processing system, hereinafter referred to as a computer system, used implementing the exemplary data flow embodiments as illustrated in FIG. 1 to FIG. 4. The computer system 500 includes at least a processor 504. It should be understood although FIG. 5 illustrates a single processor, one skilled in the art would appreciate that more than one processor can be included as needed. The processor 504 is connected to a communication infrastructure 502 (for example, a communications bus, cross-over bar, or network) where the communication infrastructure 504 is configured to facilitate communication between various elements of the exemplary computer system 500. Various software embodiments are described in terms of this exemplary computer system. After reading this description, it will become apparent to a person of ordinary skill in the relevant art(s) how to implement the invention using other computer systems and/or computer architectures.

Exemplary computer system 500 can include a display interface 508 configured to forward graphics, text, and other data from the communication infrastructure 502 (or from a frame buffer not shown) for display on a display unit 510. The computer system 500 also includes a main memory 506, which can be random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. The removable storage unit 518, represents, for example, a floppy disk, magnetic tape, optical disk, etc., which is read by and written to by the removable storage drive 516. As will be appreciated, the removable storage unit 518 includes a computer usable storage medium having stored therein computer software and/or data.

In exemplary embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system 500.

The computer system 500 may also include a communications interface 524. The communications interface 524 allows software and data to be transferred between the computer system and external devices. Examples of the communications interface 524 may include a modem, a network interface (such as an Ethernet card), a communications port, a PCMCIA slot and card, etc. Software and data transferred via the communications interface 524 are in the form of signals which may be, for example, electronic, electromagnetic, optical, or other signals capable of being received by communications interface 524. These signals are provided to the communications interface 524 via a communications path (that is, channel) 526. The channel 526 carries signals and may be implemented using wire or cable, fiber optics, a phone line, a cellular phone link, an RF link, and/or other communications channels.

With reference to the embodiments disclosed, the terms “computer program medium,” “computer usable medium,” and “computer readable medium” are used to generally refer to media such as the main memory 506 and the secondary memory 512, the removable storage drive 516, a hard disk installed in the hard disk drive 514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also referred to herein as computer control logic) are stored in the main memory 506 and/or the secondary memory 512. Computer programs may also be received via the communications interface 524. Such computer programs, when executed, can enable the computer system to perform the features of exemplary embodiments of the present invention as discussed herein. In particular, the computer programs, when executed, enable the processor 504 to perform the features of the computer system 500. Accordingly, such computer programs represent controllers of the computer system.

A system such as a data processing system as illustrated in FIG. 5, which may also include an apparatus, a device, or an article of manufacture comprising one of the following items is an example of the invention: plans, groups, footprints, digital delivery media, display point, virtual world, Avatar, computer system, simulated environment, distance, advertisement location, three-dimensional characters, characters, advertising plan, advertising content, advertising sponsors, rules, display distance rules, charge rates, display types, slides, banners, videos, digital advertising media, group rules, rotation time rules, weighted average distance, average distance, weights, extraction, viewable distance rules, group distance rules, charge accounts or any display device applying the method mentioned above, for the purpose of the current invention or a method for distance dependent advertising in virtual worlds.

The embodiments disclosed above may be implemented as a method, apparatus or article of manufacture involving software, firmware, micro-code, hardware such as logic, memory and/or any combination thereof. The term “article of manufacture” as used herein refers to code or logic and memory implemented in a medium, where such medium may include hardware logic and memory [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also include transmission signals propagating through space or a transmission media, such as an optical fiber, copper wire, etc.

The transmission signal in which the code or logic is encoded may further include a wireless signal, satellite transmission, radio waves, infrared signals, Bluetooth, the internet etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Certain embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Elements that are in communication with each other need not be in continuous communication with each other, unless expressly specified otherwise. In addition, elements that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently. Further, some or all steps may be performed in run-time mode.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

Although exemplary embodiments of the invention have been described in detail, it should be understood that various changes, substitutions and alternations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for advertising for virtual world, the method comprising:
identifying at least one virtual users in a virtual world, wherein the at least one virtual user is within a viewable distance of at least one advertisement display point;
creating a distance dependent advertising plan for the advertisement display point that varies based on the distance between the virtual user and the at least one advertisement display point, wherein the advertisement plan contains a plurality of different advertising content items for presenting within the advertisement display point, wherein different ones of the different advertising content items are presented in accordance with the advertisement plan when the virtual user is at different distances from the at least one advertisement display point; and
displaying the different advertising content items at the advertising display point in the virtual world based on the advertising plan.

2. The method as claimed in claim 1, further comprising
computing at least one of the user's distance and a group distance to the advertising display point; and
searching for the advertisement plan based on at least one of the user's distance and the group distance from the advertisement display point.

3. The method as claimed in claim 1, further comprising:
extracting a set of predefined rules for at least one of the user's distance or the group distance from the advertisement plan;
applying the set of predefined rules on the one or more advertisement content items for the advertisement display point.

4. The method as claimed in claim 1, further comprising
extracting a charge rate from the advertisement plan for the one or more advertisement content items for the advertisement display point; and
updating charge accounts of an advertising sponsor of the one or more advertising content items with the charge rate and the set of predefined rules.

5. The method as claimed in claim 1, wherein the virtual users are avatars, and wherein each of the avatars is a representation of a real world character in the virtual world as a three-dimensional character.

6. The method as claimed in claim 1, wherein the advertising display point is a fixed relative region of space in the virtual world within which the different advertising content items are displayed.

7. The method as claimed in claim 1, wherein the advertisement plan includes a plurality of different advertising sponsors, each associated with a different one of the different advertising content items, wherein each of the different advertising sponsors pays a fee for having the corresponding advertising content item selectively presented upon the advertising display point of the virtual world.

8. The method as claimed in claim 1, wherein the advertising plan includes a display distance rule for the different advertising content items, and the advertising plan includes charge rates for the different advertising content items corresponding to one or more advertising sponsors.

9. The method as claimed in claim 1, wherein the advertising plan includes display types for the user's distance for the advertising content, and the display types include at least one of slides, banners, and videos.

10. The method as claimed in claim 1, wherein the advertising plan includes display types for the virtual user's distance from the advertising display point, and the advertising plan includes a set of rules for groups of the virtual users for average distance from the different advertising content items, and the advertising plan includes rotation time rules for the different advertising content items based on the viewable distance of the groups and the virtual users.

11. The method as claimed in claim 1, wherein displaying the one or more advertisements includes delivering the different advertising content items by one or more advertising sponsors from the advertising plan.

12. The method as claimed in claim 2, wherein the group distance is at least one of an average or weighted average distance between the user and the advertising display point.

13. The method as claimed in claim 12, wherein the group distance is the weighted average distance between the user and the advertising display point, wherein the weighted average is a sum of each user's distance times each user's weight divided by sum of the user's weight, and the user's weight is contribution of the user to the group's distance.

14. The method as claimed in claim 3, wherein the pre-defined rules are the viewable distance rules and the rotation time rules and the group rules and the group distance rules.

15. The method as claimed in claim 10, wherein the groups and the user's rates and the viewable distance rules and the rotation time rules are aggregated, averaged or combined statistically.

16. The method as claimed in claim 10, wherein the groups and the user's rates and the viewable distance rules and the rotation time rules are separately evaluated.

17. A computer program product for distance dependent advertising for virtual worlds, the computer program product comprising a computer readable storage medium having computer readable program code embodied therewith, the computer readable program code comprising computer readable program code configured for
identifying virtual users in a virtual world, wherein the virtual user are within a viewable distance of an advertisement display point, and the virtual world is a simulated environment, wherein the virtual world's users are avatars, and wherein the avatars is a representation of a real world character in the virtual world as a three-dimensional character, and the advertising display point is a location where the one or more advertising content is displayed;
creating an advertising plan, wherein the advertisement plan contains one or more advertising content for the advertisement display point, the advertisement plan includes the advertising sponsor for the one or more advertising content, the advertising plan includes a display distance rule for the one or more advertising content, and the advertising plan includes rates for the one of more advertising content for the advertising sponsor, the advertising plan includes display types for the user's distance for the advertising content, and the display types includes at least one of slides or banners or videos or a form of digital advertising media, and the advertising plan includes the display types for the user's distance from the advertising display point, and the advertising plan includes a set of rules for groups of the user's for average distance from the one or more advertising content, and the advertising plan includes rotation time rules for the one or more advertising content based on the viewable distance of the groups and the user's; and
displaying the one or more advertising content on an advertising display point, and displaying the one or more advertisements includes delivering the one of more advertising contents by one or more advertising sponsors from the advertising plan.

18. The computer program product as claimed in claim 17, further configured for
computing at least one of the user's distance or a group distance to the advertising display point, wherein the group distance is at least one of an average or weighted average distance between the user and the advertising display point, and wherein the weighted average is a sum of each user's distance times each user's weight divided by sum of the user's weight, and the user's weight is contribution of the user to the group's distance, and wherein the pre-defined rules are the viewable distance rules and the rotation time rules and the group rules and the group distance rules; and
searching the advertisement plan based on at least one of the user's distance and the group distance from the advertisement display point.

19. The computer program product as claimed in claim 17, further configured for
extracting a set of predefined rules for at least one of the user's distance or the group distance from the advertisement plan;
applying the set of predefined rules on the one or more advertisement content for the advertisement display point;
extracting a charge rate from the advertisement plan for the one or more advertisement content for the advertisement display point; and
updating charge accounts of a advertising sponsor of the one or more advertising content with a the charge rate and the set of predefined rules

20. The computer program product as claimed in claim 17, wherein the groups and the user's rates and the viewable distance rules and the rotation time rules are aggregated, averaged or combined statistically.

21. The computer program product as claimed in claim 17, wherein the groups and the user's rates and the viewable distance rules and the rotation time rules are separately evaluated.

22. A system for distance dependent advertising for virtual world, the system comprising at least one processor and at least one memory, wherein the processor is configured for
identifying virtual users in a virtual world, wherein the virtual user are within a viewable distance of an advertisement display point, and the virtual world is a simulated environment, wherein the virtual world's users are avatars, and wherein the avatars is a representation of a real world character in the virtual world as a three-dimensional character, and the advertising display point is a location where the one or more advertising content is displayed;
creating an advertising plan, wherein the advertisement plan contains one or more advertising content for the advertisement display point, the advertisement plan includes the advertising sponsor for the one or more advertising content, the advertising plan includes a display distance rule for the one or more advertising content, and the advertising plan includes rates for the one of more advertising content for the advertising sponsor, the advertising plan includes display types for the user's distance for the advertising content, and the display types includes at least one of slides or banners or videos or a form of digital advertising media, and the advertising plan includes the display types for the user's distance from the advertising display point, and the advertising plan includes a set of rules for groups of the user's for average distance from the one or more advertising content, and the advertising plan includes rotation time rules for the one or more advertising content based on the viewable distance of the groups and the user's; and
displaying the one or more advertising content on an advertising display point, and displaying the one or more advertisements includes delivering the one of more advertising contents by one or more advertising sponsors from the advertising plan.

23. The system as claimed in claim 21, further configured for
computing at least one of the user's distance or a group distance to the advertising display point, wherein the group distance is at least one of an average or weighted average distance between the user and the advertising display point, and wherein the weighted average is a sum of each user's distance times each user's weight divided by sum of the user's weight, and the user's weight is contribution of the user to the group's distance, and wherein the pre-defined rules are the viewable distance rules and the rotation time rules and the group rules and the group distance rules; and
searching the advertisement plan based on at least one of the user's distance and the group distance from the advertisement display point.

24. The system as claimed in claim 22, further configured for
extracting a set of predefined rules for at least one of the user's distance or the group distance from the advertisement plan;
applying the set of predefined rules on the one or more advertisement content for the advertisement display point;
extracting a charge rate from the advertisement plan for the one or more advertisement content for the advertisement display point; and
updating charge accounts of a advertising sponsor of the one or more advertising content with a the charge rate and the set of predefined rules

25. The system as claimed in claim 23, wherein the groups and the user's rates and the viewable distance rules and the rotation time rules are aggregated, averaged or combined statistically.

26. The system as claimed in claim 23, wherein the groups and the user's rates and the viewable distance rules and the rotation time rules are separately evaluated.

27. A method for distance dependent advertising in a virtual world, the method comprising:
identifying users in a virtual world, wherein the users are in a viewable distance from an advertisement display point, in a virtual environment;
displaying a plurality of sets of information on the advertisement display point in accordance with an advertisement plan, wherein the plurality of sets information includes advertisement content, the advertisement plan including an advertisement sponsor, and the advertising plan containing a charge rate for the advertisement content for the advertising sponsor;
computing a distance of each of the users from the advertisement display point in the virtual environment; and
on determining that each of the users reaches a predetermined distance from the advertisement display point, enabling each of the users at respective predetermined distances from the advertisement display point to view a distinct advertisement content from among the plurality of sets of information.
